(19) United States
(12) Patent Application Publication
(10) Pub. No.: US 2023/0198328 A1
(43) Pub. Date: Jun. 22, 2023

(54) STATOR, MOTOR, COMPRESSOR, REFRIGERATION CYCLE APPARATUS, AND AIR CONDITIONER

(71) Applicant: Mitsubishi Electric Corporation, Tokyo (JP)

(72) Inventors: Emi TSUKAMOTO, Tokyo (JP); Masahiro NIGO, Tokyo (JP)

(21) Appl. No.: 17/923,396

(22) PCT Filed: Jun. 24, 2020
(86) PCT No.: PCT/JP2020/024696

§ 371 Date: Nov. 7, 2022

(51) Int. Cl. H02K 3/34; H02K 1/16; H02K 1/27; F25B 1/04; F25B 31/02

(52) U.S. Cl. CPC H02K 3/34; H02K 1/16; H02K 1/27; F25B 1/04; F25B 31/026

(57) ABSTRACT

A stator includes a stator core having a yoke and a tooth, an insulator provided on the tooth, and a coil wound around the tooth via the insulator. The yoke has a first hole provided in an end surface in an axial direction of the stator core. The tooth has a second hole provided in the end surface. The second hole is provided at the center of the tooth in a circumferential direction of the stator core and arranged on a straight line passing through the first hole and extending in a radial direction of the stator core. The insulator has a first convex portion fitting into the first hole and a second convex portion fitting into the second hole.

### CROSS REFERENCE TO RELATED APPLICATION

This application is a U.S. national stage application of International Patent Application No. PCT/JP2020/024696 filed on Jun. 24, 2020, the disclosure of which is incorporated herein by reference.

### TECHNICAL FIELD

The present disclosure relates to a stator, a motor, a compressor, a refrigeration cycle apparatus and an air conditioner.

### BACKGROUND

There is known a stator that includes a stator core having a yoke and a tooth, an insulator provided on the tooth, and a coil wound around the tooth via the insulator (see, for example, Patent Reference 1). In Patent Reference 1, the yoke of the stator core has a hole provided in an end surface in the axial direction of the stator core, and the insulator has a convex portion that fits into the hole.

### PATENT REFERENCE

[Patent Reference 1]

International Publication WO 2018/051407

However, in Patent Reference 1, the hole is provided only in the yoke. Thus, when the work of winding the coil around the tooth is performed, the tensile force of the coil may be applied to the insulator, and may cause misalignment of the insulator. If the area of the hole as viewed in the axial direction is increased, the insulator can be firmly fixed to the stator core, but magnetic paths of the magnetic flux flowing on both sides of the hole in the circumferential direction are narrowed. This causes magnetic saturation.

### SUMMARY

An object of the present disclosure is to prevent misalignment of an insulator and also prevent occurrence of magnetic saturation.

A stator according to an aspect of the present disclosure includes a stator core having a yoke and a tooth, an insulator provided on the tooth, and a coil wound around the tooth via the insulator. The yoke has a first hole provided in an end surface in an axial direction of the stator core. The tooth has a tooth main body extending inward in the radial direction from the yoke, and a tooth tip end arranged on an inner side in the radial direction with respect to the tooth main body. The tooth tip end is wider in the circumferential direction of the stator core than the tooth main body. The tooth has a second hole provided in the end surface. The second hole is provided at a center of the tooth in a circumferential direction of the stator core and arranged on a straight line passing through the first hole and extending in a radial direction of the stator core. The insulator has a first convex portion fitting into the first hole and a second convex portion fitting into the second hole. The second hole is provided in the tooth tip end.

According to the present disclosure, misalignment of an insulator can be prevented and the occurrence of magnetic saturation can also be prevented.

### BRIEF DESCRIPTION OF THE DRAWINGS

FIG. 1 is a sectional view illustrating the configuration of a motor according to a first embodiment.

FIG. 2 is a sectional view of the motor taken along the line A2-A2 in FIG. 1.

FIG. 3 is a plan view illustrating the configuration of a first core part of a stator core of a stator according to the first embodiment.

FIG. 4 is a plan view illustrating the configuration of a second core part of the stator core according to the first embodiment.

FIG. 5 is an enlarged plan view illustrating the configuration of the second core part illustrated in FIG. 4.

FIG. 6 is a schematic diagram illustrating the flow of magnetic flux in the second core part according to the first embodiment.

FIG. 7 is a perspective view illustrating a part of the stator according to the first embodiment.

FIG. 8 is a perspective view illustrating the configuration of an insulator of the stator according to the first embodiment.

FIG. 9 is a sectional view illustrating the configuration of a rotor according to the first embodiment.

FIG. 10 is a sectional view illustrating the configuration of a motor according to a second embodiment.

FIG. 11 is an enlarged plan view illustrating the configuration of a second core part according to the second embodiment.

FIG. 12 is a schematic diagram illustrating the flow of magnetic flux in the second core part according to the second embodiment.

FIG. 13 is an enlarged plan view illustrating the configuration of a second core part according to a third embodiment.

FIG. 14 is an enlarged plan view illustrating the configuration of a second core part according to a fourth embodiment.

FIG. 15 is a sectional view illustrating the configuration of a motor according to a fifth embodiment.

FIG. 16 is a diagram illustrating the configuration of an insulator of a stator according to a sixth embodiment.

FIG. 17 is a block diagram illustrating the configuration of a motor drive device according to a seventh embodiment.

FIG. 18 is a partial sectional view illustrating the configuration of a compressor according to an eighth embodiment.

FIG. 19 is a diagram illustrating the configuration of an air conditioner according to a ninth embodiment.

### DETAILED DESCRIPTION

Hereinafter, a description will be given on a stator, a motor, a compressor, a refrigeration cycle apparatus and an air conditioner according to embodiments of the present disclosure with reference to the drawings. The following embodiments are illustrative only, and any combination of the embodiments and any changes to each embodiment can be made as appropriate.

In the drawings, the xyz orthogonal coordinate system is illustrated in order to facilitate understanding of the description. The z-axis is a coordinate axis parallel to the axis of a rotor of the motor. The x-axis is a coordinate axis orthogonal to the z-axis. The y-axis is a coordinate axis orthogonal to both the x-axis and the z-axis.

### First Embodiment

### (Motor)

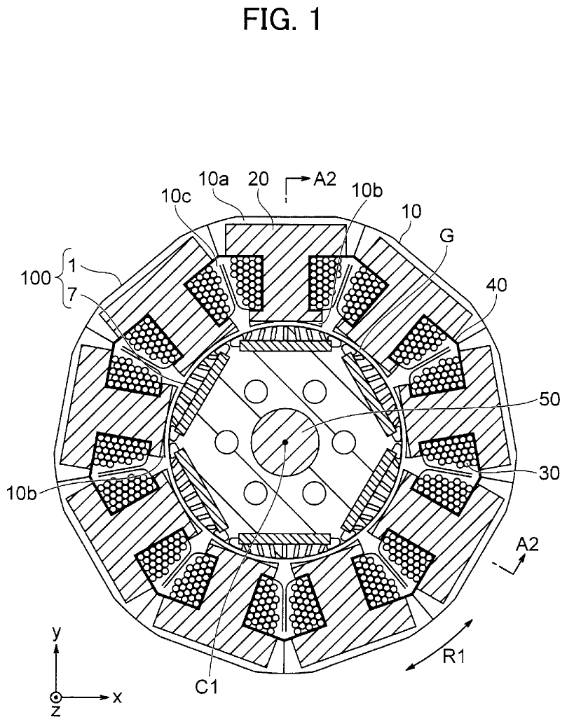

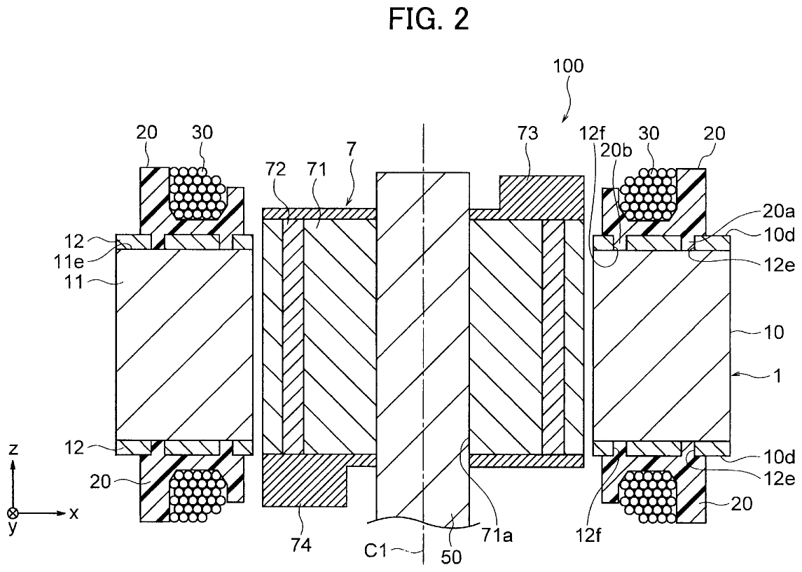

FIG. 1 is a sectional view illustrating the configuration of a motor 100 according to a first embodiment. FIG. 2 is a sectional view of the motor 100, taken along the line A2-A2 in FIG. 1. As illustrated in FIGS. 1 and 2, the motor 100 has a stator 1 and a rotor 7 fixed to a shaft 50. The rotor 7 is disposed on the inner side of the stator 1. An air gap G is formed between the stator 1 and the rotor 7. The air gap G is a gap which is set within a range of, for example, 0.3 mm to 1.0 mm.

The rotor 7 is rotatable about an axis C1 of the shaft 50. The shaft 50 extends in the z-axis direction. In the following description, the direction along the circumference of a circle about the axis C1 of the shaft 50 (for example, as indicated by the arrow R1 in FIG. 1) is referred to as a “circumferential direction”, and the direction of a straight line orthogonal to the z-axis direction and passing through the axis C1 is referred to as a “radial direction”.

### (Stator)

Next, the configuration of the stator 1 will be described. The stator 1 has a stator core 10, insulators 20, and coils 30.

The stator core 10 is an annular member about the axis C1. The stator core 10 has a yoke 10a and a plurality of teeth 10b extending inward in the radial direction from the yoke 10a. A slot 10c, which is a space for housing the coil 30 therein, is formed between adjacent ones of the plurality of teeth 10b. Incidentally, other configurations of the stator core 10 will be described later.

The insulator 20 covers the yoke 10a and the tooth 10b from outside in the z-axis direction. Thus, the stator core 10 and the coil 30 are insulated from each other. Incidentally, the configuration of the insulator 20 will be described later.

The coil 30 is wound around the tooth 10b via the insulator 20. The coil 30 is made of, for example, a magnet wire. The winding method of the coil 30 is, for example, a concentrated winding in which the coil 30 is wound around each tooth 10b. The wire diameter and number of turns of coils 30 are determined based on the properties required for the motor 100 (for example, rotation speed or torque), voltage specifications, the cross-sectional area of the slot 10c, and the like. For example, the coil 30 having a wire diameter of about 1.0 mm is wound about 80 turns around each tooth 10b. The stator 1 has, for example, three-phase (i.e., U-phase, V-phase, and W-phase) coils 30. The connection state of the coils 30 is, for example, a star connection where the three-phase coils 30 are connected to each other at the neutral point. Incidentally, the connection state of the coils 30 is not limited to the star connection, but may be a delta connection.

The stator 1 further has an insulating film 40 disposed in the slot 10c. Thus, a surface defining the slot 10c in the stator core 10 (for example, the side surface of the tooth 10b facing in the circumferential direction R1) and the coil 30 can be insulated from each other. Incidentally, the stator 1 may be implemented so that the stator 1 has no insulating film 40. That is, the insulator 20 may entirely cover the surface of the tooth 10b.

As illustrated in FIG. 2, the stator core 10 has a first core part 11 and second core parts 12 which are arranged in the z-axis direction. Each second core part 12 is disposed on the outer side of the first core part 11 in the z-axis direction. The first core part 11 and the second core part 12 are fixed to each other, for example, by crimping. In the first embodiment, the stator core 10 has a plurality of second core parts 12 disposed on both sides of the first core part 11 in the z-axis direction. Incidentally, the stator core 10 may have one second core part 12 disposed on either side of the first core part 11 in the z-axis direction.

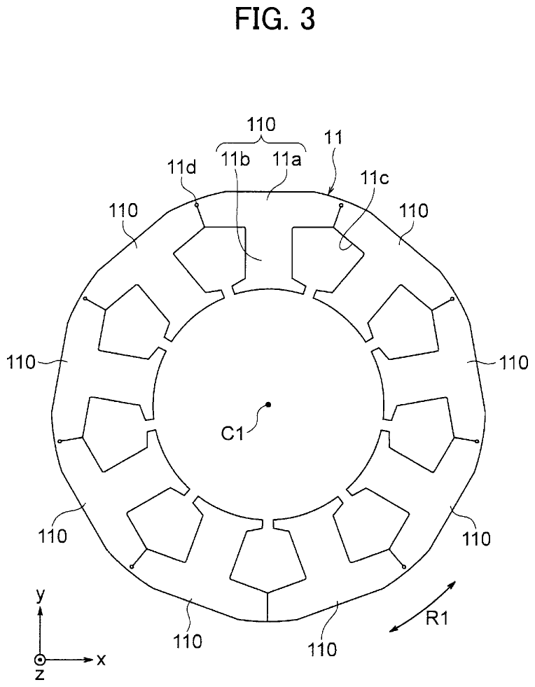

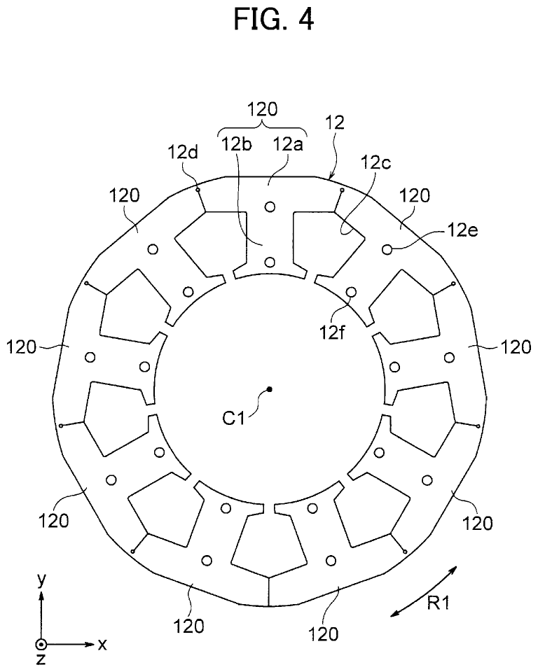

FIG. 3 is a plan view illustrating the configuration of the first core part 11. FIG. 4 is a plan view illustrating the configuration of the second core part 12. As illustrated in FIGS. 1, 3, and 4, the yoke 10a has first yoke portions 11a provided in the first core part 11 and second yoke portions 12a provided in the second core part 12. Each tooth 10b has a first tooth portion 11b provided in the first core part 11 and a second tooth portion 12b provided in the second core part 12. Each slot 10c has a first slot portion 11c provided in the first core part 11 and a second slot portion 12c provided in the second core part 12.

As illustrated in FIG. 3, the first core part 11 is formed of a plurality of split cores 110 arranged in the circumferential direction R1. Each split core 110 has the first yoke portion 11a and the first tooth portion 11b described above. Adjacent split cores 110 of the plurality of split cores 110 are connected to each other via a connecting portion 11d formed in the first yoke portion 11a. Incidentally, the first core part 11 is not limited to the configuration in which a plurality of split cores 110 are connected together, but may also be configured of a single annular core.

As illustrated in FIG. 4, the second core part 12 is formed of a plurality of split cores 120 arranged in the circumferential direction R1. The split core 120 has the second yoke portion 12a and the second tooth portion 12b described above. Adjacent split cores 120 of the plurality of split cores 120 are connected to each other via a connecting portion 12d formed in the second yoke portion 12a. Incidentally, the second core part 12 is not limited to the configuration in which a plurality of split cores 120 are connected together, but may also be configured of a single annular core.

The second yoke portion 12a has a first hole 12e provided in an end surface 10d in the z-axis direction of the stator core 10. The second tooth portion 12b has a second hole 12f provided in the end surface 10d. A first convex portion 20a of the insulator 20 fits into the first hole 12e, while a second convex portion 20b of the insulator 20 fits into the second hole 12f (see FIG. 2). That is, in the first embodiment, the stator core 10 has two holes for fixing each insulator 20. Consequently, the insulator 20 can be firmly fixed to the stator core 10.

Here, when the work of winding the coil around the tooth via the insulator is performed, the force that causes the insulator to rotate in the circumferential direction R1 (for example, the tensile force of the coil) is applied to the insulator. With this force, the insulator slips relative to the tooth, and may cause misalignment of the insulator. If the force applied to the insulator is large, the base of the insulator (i.e., the end of the insulator in the axial direction in contact with the stator core) may be deformed or cracked. In the first embodiment, the stator core 10 has the first holes 12e provided in the yoke 10a and the second holes 12f provided in the teeth 10b. Thus, the force applied to the insulator 20 can be dispersed when the work of winding the coil 30 around the tooth 10b is performed. Thus, the occurrence of misalignment of the insulator 20 can be prevented, and the deformation or cracking at the base of the insulator 20 can be prevented. Consequently, it is possible to maintain the state where the insulator 20 insulates the stator core 10 and the coil 30 from each other. Thus, in the first embodiment, one insulator 20 is supported at two points with respect to the stator core 10, and therefore misalignment of the insulator 20 is less likely to occur, as compared to a case where one insulator is supported at one point with respect to the stator core 10.

In the first embodiment, the second yoke portion 12a has one first hole 12e, and the second tooth portion 12b has one second hole 12f. However, the second yoke portion 12a may have a plurality of first holes 12e, and the second tooth portion 12b may have a plurality of second holes 12f. That is, the number of holes provided in the end surface 10d of the stator core 10 only needs to be two or more.

The first hole 12e and the second hole 12f penetrate the second core part 12 in the z-axis direction. The bottom of the first hole 12e and the bottom of the second hole 12f correspond to an end surface 11e in the z-axis direction of the first core part 11. That is, in the first embodiment, the first core part 11 has no hole which is used to fix the insulator 20 (see FIG. 2).

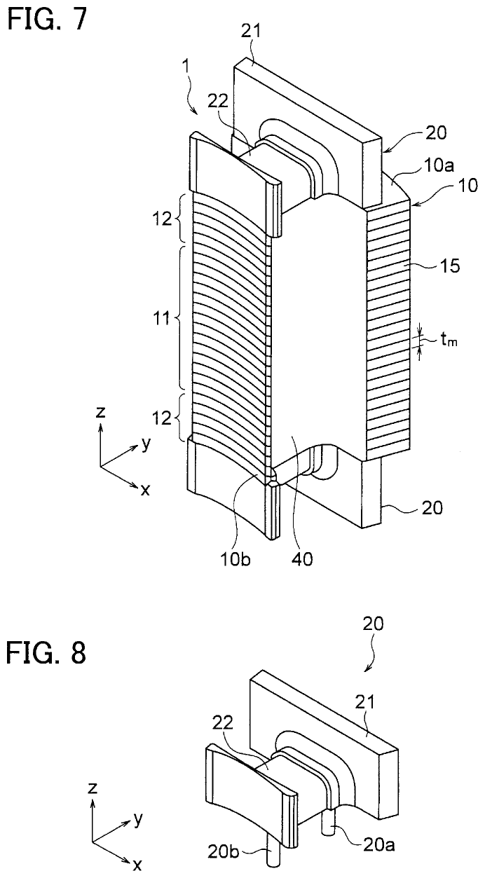

As illustrated in FIG. 7 described later, the second core part 12 has a plurality of electromagnetic steel sheets 15 stacked in the z-axis direction. The first hole 12e and the second hole 12f are formed by punching the electromagnetic steel sheets 15.

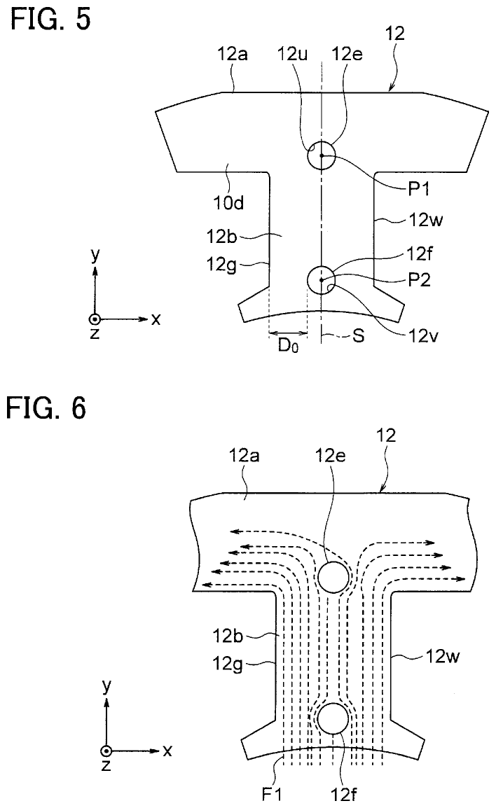

FIG. 5 is an enlarged plan view illustrating the configuration of the second core part 12. An opening 12u of the first hole 12e and an opening 12v of the second hole 12f have the same shape as each other. In the first embodiment, the opening 12u of the first hole 12e and the opening 12v of the second hole 12f are circular. Thus, the first hole 12e and the second hole 12f can be formed easily by a punching process. Incidentally, the opening 12u of the first hole 12e and the opening 12v of the second hole 12f are not limited to the circular shape, but may have other shapes such as an oval shape. The opening 12u of the first hole 12e and the opening 12v of the second hole 12f may have different shapes. For example, one of the opening 12u of the first hole 12e and the opening 12v of the second hole 12f may be circular, while the other may be non-circular (see FIG. 14 to be described later).

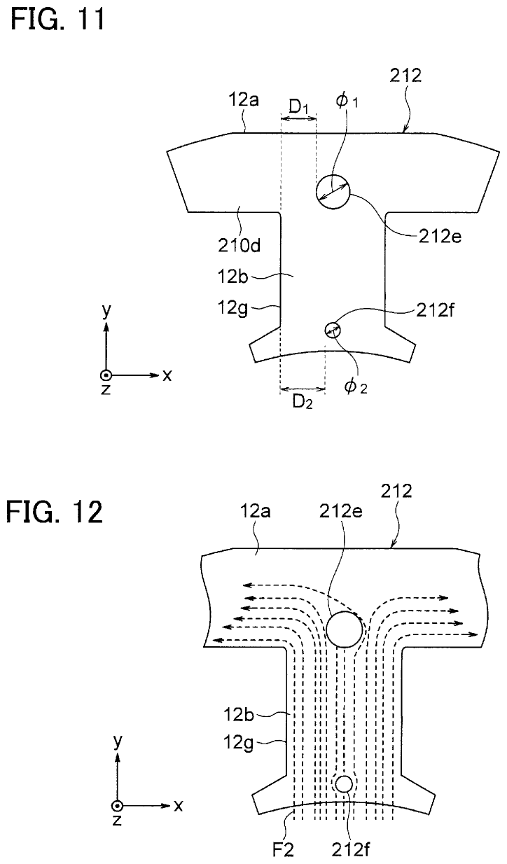

The area of the first hole 12e and the area of the second hole 12f as viewed in the z-axis direction are the same as each other. In other words, in the first embodiment, the first hole 12e and the second hole 12f have the same diameter as each other. The diameter of each of the first hole 12e and the second hole 12f is, for example, 5 mm. However, the area of the first hole 12e and the area of the second hole 12f as viewed in the z-axis direction may be different from each other. For example, the area of the second hole 12f may be smaller than the area of the first hole 12e (see FIG. 11 to be described later).

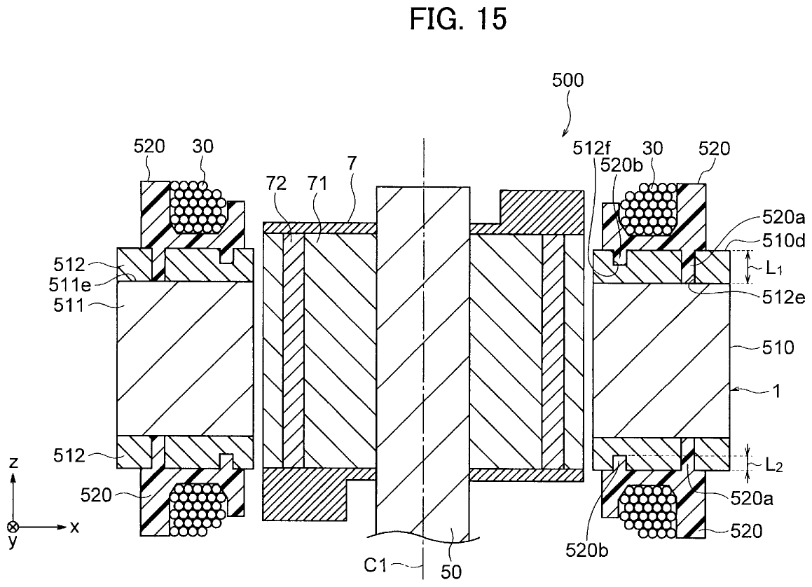

The first hole 12e and the second hole 12f have the same depth as each other. However, the first hole 12e and the second hole 12f may have different depths. For example, the depth of the second hole 12f may be shallower than the depth of the first hole 12e (see FIG. 15 to be described later).

The first hole 12e is provided at the center of the second yoke portion 12a in the circumferential direction R1. The second hole 12f is provided at the center of the second tooth portion 12b in the circumferential direction R1. In the first embodiment, a center point P1 of the first hole 12e is provided at the center of the second yoke portion 12a in the circumferential direction R1. A center point P2 of the second hole 12f is provided at the center of the second tooth portion 12b in the circumferential direction R1. The second hole 12f is arranged on a straight line S passing through the first hole 12e and extending in the radial direction. In other words, the first hole 12e and the second hole 12f are arranged on the same straight line S.

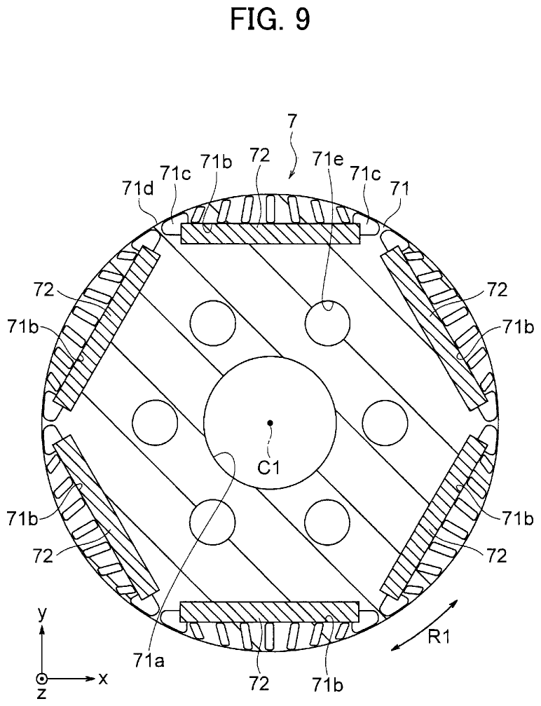

FIG. 6 is a schematic diagram illustrating the flow of magnetic flux F1 in the second core part 12 illustrated in FIG. 5. As illustrated in FIG. 6, the magnetic flux F1 from a permanent magnet (i.e., a permanent magnet 72 in FIG. 9 to be described later) flows from the second tooth portion 12b toward the second yoke portion 12a.

Here, the second tooth portion 12b has a side surface 12g facing one direction in the circumferential direction R1 and a side surface 12w facing the other direction in the circumferential direction R1. In FIG. 6, the amount of magnetic flux F1 flowing between an edge of the second hole 12f and the side surface 12g is substantially equal to the amount of magnetic flux F1 flowing between an edge of the second hole 12f and the side surface 12w. This is because the second hole 12f (the center point P2 in the first embodiment) is disposed at the center of the second tooth portion 12b in the circumferential direction R1. In other words, the widths of the magnetic paths through which the magnetic flux F1 flows on both sides of the second hole 12f in the circumferential direction R1 are equal to each other. Thus, the occurrence of magnetic saturation can be suppressed on both sides of the second hole 12f in the circumferential direction R1. Consequently, the iron loss in the stator 1 is reduced, and a reduction in the efficiency of the motor 100 is suppressed.

In the first embodiment, the amounts of magnetic flux on both sides of the first hole 12e in the circumferential direction R1 are substantially equal. This is because the first hole 12e and the second hole 12f are arranged on the same straight line S, and thus the shortest path through which the magnetic flux F1 flows is secured between the first hole 12e and the second hole 12f. In general, magnetic flux has the property of flowing through the shortest path. Thus, in the first embodiment, the magnetic flux F1, which passes through both sides of the second hole 12f in the circumferential direction R1, flows toward the first hole 12e through the shortest path. Therefore, variation in the amount of magnetic flux (i.e., the magnetic flux density) on both sides of the first hole 12e in the circumferential direction R1 is less likely to occur. Consequently, the occurrence of magnetic saturation can be further suppressed.

In the first embodiment, the first hole 12e and the second hole 12f are arranged on the straight line S in such a manner that the center point P1 and the center point P2 are located on the straight line S. This further facilitates securing the shortest path through which the magnetic flux F1 flows, between the first hole 12e and the second hole 12f. Incidentally, one of the center points P1 and P2 may be disposed at a position that slightly shifts to one side in the circumferential direction R1 relative to the straight line S.

FIG. 7 is a perspective view illustrating a part of the stator 1 illustrated in FIG. 1 or 2. As illustrated in FIG. 7, the stator core 10 has a plurality of electromagnetic steel sheets 15 which are stacked in the z-axis direction and serve as a plurality of steel sheets. The sheet thickness tₘ of each electromagnetic steel sheet 15 is set within a range of, for example, 0.1 mm to 0.7 mm. In the first embodiment, the sheet thickness tₘ of each electromagnetic steel sheet 15 is 0.35 mm. The electromagnetic steel sheets 15 are processed into a predetermined shape by the punching process using a press die. The plurality of electromagnetic steel sheets 15 are fastened together by welding, crimping, bonding, or the like.

In FIG. 7, each of the first core part 11 and the second core parts 12 has a plurality of electromagnetic steel sheets 15. However, either the first core part 11 or the second core part 12 may be formed of a single electromagnetic steel sheet 15.

Next, the configuration of the insulator 20 will be described. FIG. 8 is a perspective view illustrating the configuration of the insulator 20. As illustrated in FIG. 8, the insulator 20 has the first convex portion 20a that fits into the first hole 12e and a second convex portion 20b that fits into the second hole 12f. The first convex portion 20a is formed in a first insulating portion 21 covering the yoke 10a. The second convex portion 20b is formed in a second insulating portion 22 covering the tooth 10b. The first convex portion 20a and the second convex portion 20b are columnar. In the first embodiment, the first convex portion 20a and the second convex portion 20b are, for example, cylindrical.

The length of the first convex portion 20a in the z-axis direction corresponds to the depth of the first hole 12e, and the length of the second convex portion 20b in the z-axis direction corresponds to the depth of the second hole 12f. In the first embodiment, since the depth of the first hole 12e is the same as the depth of the second hole 12f as described above, the length of the first convex portion 20a in the z-axis direction is the same as the length of the second convex portion 20b in the z-axis direction. However, the length of the first convex portion 20a in the z-axis direction may be different from the length of the second convex portion 20b in the z-axis direction. For example, the length of the second convex portion 20b in the z-axis direction may be shorter than the length of the first convex portion 20a in the z-axis direction (see FIG. 15 to be described later).

The insulator 20 is formed of a resin material. In the first embodiment, the insulator 20 is formed of, for example, a polybutylene terephthalate resin (hereinafter also referred to as a “PBT resin”). In general, a PBT resin has a weaker tensile strength than other resin materials, and thus is easily elastically deformed. Thus, when the work of mounting the insulator 20 onto the stator core 10 is performed, the insulator 20 is appropriately deformed elastically. Therefore, the first convex portion 20a can easily fit into the first hole 12e and the second convex portion 20b can easily fit into the second hole 12f. Therefore, the work of mounting the insulator 20 is facilitated. Incidentally, the insulator 20 may be formed of a mixed resin containing a PBT resin and other resin materials. That is, the insulator 20 only needs to contain a PBT resin.

### (Rotor)

Next, the configuration of the rotor 7 will be described. FIG. 9 is a sectional view illustrating the configuration of the rotor 7. As illustrated in FIGS. 2 and 9, the rotor 7 has a rotor core 71 supported by the shaft 50 and the plurality of permanent magnets 72 mounted in the rotor core 71.

The rotor core 71 has a shaft insertion hole 71a into which the shaft 50 is inserted. The shaft 50 is fixed to the shaft insertion hole 71a by shrink-fitting, press-fitting, or the like. Thus, the rotational energy generated when the shaft 50 rotates is transferred to the rotor core 71.

The rotor core 71 has a plurality of electromagnetic steel sheets (not shown) stacked in the z-axis direction. The sheet thickness of each electromagnetic steel sheet of the rotor core 71 is set within a range of, for example, 0.1 mm to 0.7 mm. In the first embodiment, the sheet thickness of each electromagnetic steel sheet used for the rotor core 71 is, for example, 0.35 mm.

As illustrated in FIG. 9, the rotor core 71 has a plurality of magnet insertion holes 71b which serve as a plurality of magnet mounting portions. The plurality of magnet insertion holes 71b are arranged in the circumferential direction R1. The shape of the magnet insertion hole 71b is, for example, straight as viewed in the z-axis direction. For example, one permanent magnet 72 is inserted in each magnet insertion hole 71b. In FIG. 9, the rotor core 71 has six magnet insertion holes 71b. Here, the number of poles in the motor 100 corresponds to the number of magnet insertion holes 71b (i.e., the number of permanent magnets 72). In FIG. 9, the number of poles in the motor 100 is six, for example. Incidentally, the number of poles in the motor 100 is not limited to six and only needs to be two or more. The shape of the magnet insertion hole 71b as viewed in the z-axis direction may be a V shape which is convex toward the inner side or the outer side in the radial direction. A plurality of (for example, two) permanent magnets 72 may be inserted into the magnet insertion hole 71b.

The rotor core 71 further has flux barriers 71c as leakage magnetic flux suppression holes. The flux barrier 71c is formed on each side of the magnet insertion hole 71b in the circumferential direction R1. A thin-walled portion is formed between the flux barrier 71c and an outer circumference 71d of the rotor core 71 and thereby suppresses the leakage magnetic flux between adjacent magnetic poles. The width of the thin-walled portion is the same as the sheet thickness of each electromagnetic steel sheet of the rotor core 71, for example. This can prevent short-circuit of the magnetic flux while securing the strength of the rotor core 71.

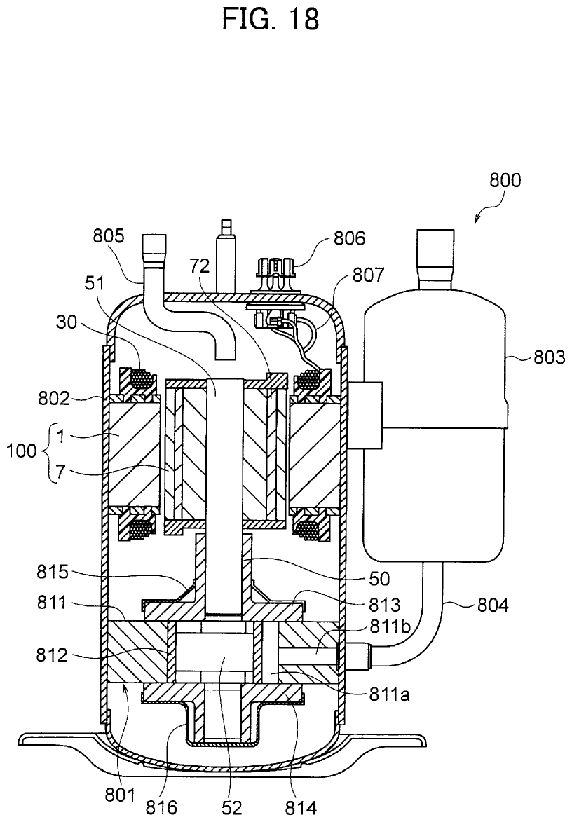

The rotor core 71 further has a plurality (in FIG. 9, six) of through holes 71e that penetrate the rotor core 71 in the z-axis direction. The plurality of through holes 71e are formed on the inner side of the magnet insertion holes 71b in the radial direction. When the motor 100 is applied to a compressor (i.e., a compressor 800 illustrated in FIG. 18 to be described later), the compressed refrigerant passes through the through holes 71e.

The permanent magnet 72 is embedded in the magnet insertion hole 71b of the rotor core 71. That is, in the first embodiment, the rotor 7 has an Interior Permanent Magnet (IPM) structure. Thus, the permanent magnet 72 can be prevented from falling out of the rotor core 71 due to a centrifugal force generated during rotation of the rotor 7. Incidentally, the structure of the rotor 7 is not limited to the IPM structure, but may be a Surface Permanent Magnet (SPM) structure in which the permanent magnets 72 are attached to the outer circumference 71d of the rotor core 71.

The permanent magnet 72 is composed of a rare earth magnet that contains neodymium (Nd), iron (Fe) and boron (B), for example. Incidentally, the permanent magnet 72 is not limited to the rare earth magnet but may be other permanent magnets such as a ferrite magnet.

Next, the relationship between the coercive force of the permanent magnet 72 and the residual magnetic flux density will be described. In general, the coercive force of a permanent magnet decreases as the temperature increases. When a motor is placed in an atmosphere of high temperature (for example, 100° C. or higher), the coercive force of the permanent magnet in a rotor decreases. For example, the coercive force decreases at a rate of about 0.5%/ΔK to 0.6%/ΔK as the temperature increases. When the coercive force decreases at a rate of about 0.5%/ΔK, the coercive force at high temperature (for example, 130° C.) decreases by about 65%, as compared to the coercive force at normal temperature (for example, 20° C.)

When the motor 100 is applied to a compressor, the coercive force required to prevent demagnetization of the permanent magnet at the maximum load of the compressor is within a range of 1100 A/m to 1500 A/m. For example, in the case where the motor 100 is placed in a refrigerant atmosphere at 150° C., the coercive force at normal temperature needs to be within a range of about 1800 A/m to about 2300 A/m.

Here, dysprosium (Dy), which is a heavy rare earth element, may be added to the permanent magnet in order to improve its coercive force. For example, in order to obtain the coercive force of about 2300 A/m described above, about 2.0% by weight of Dy may be added to the permanent magnet. However, Dy is a rare earth resource, and thus is expensive and difficult to obtain. In addition, when Dy is added to the permanent magnet, the residual magnetic flux density decreases. When the residual magnetic flux density decreases, the magnet torque of the motor also decreases, and the energization current increases. This increases copper loss. Consequently, the motor efficiency is reduced. In the first embodiment, the permanent magnet 72 does not contain Dy. That is, in the first embodiment, the Dy content in the permanent magnet 72 is 0% by weight. This can reduce the manufacturing cost of the permanent magnet 72 and can prevent a reduction in the efficiency of the motor 100. Incidentally, in the first embodiment, the coercive force of the permanent magnet 72 at normal temperature is about 1800 A/m. Therefore, even when the motor 100 is applied to a compressor, demagnetization of the permanent magnet 72 can be prevented. Incidentally, the permanent magnet 72 may contain Dy.

As illustrated in FIG. 2, the rotor 7 further has a plurality of end plates 73 and 74 fixed to both ends of the rotor core 71 in the z-axis direction. Thus, the rotational balance of the rotor 7 can be improved, and the inertial force of the rotor 7 can be increased. Since the rotor 7 has the end plates 73 and 74, the permanent magnets 72 are further less likely to fall out of the rotor core 71. Incidentally, the rotor 7 can be implemented so that the rotor 7 does not have one or both of the end plates 73 and 74.

### (Effects of First Embodiment)

As described above, according to the first embodiment, the insulator 20 has the first convex portion 20a that fits into the first hole 12e provided in the yoke 10a and the second convex portion 20b that fits into the second hole 12f provided in the tooth 10b. Thus, when the work of winding the coil 30 around the tooth 10b is performed, the force that causes the insulator 20 to rotate in the circumferential direction R1 relative to the tooth 10b can be dispersed. Thus, the occurrence of misalignment of the insulator 20 can be prevented.

According to the first embodiment, the center point P2 of the second hole 12f is disposed at the center of the second tooth portion 12b in the circumferential direction R1. Thus, the widths of the magnetic paths formed on both sides of the second hole 12f in the circumferential direction R1 are equal to each other. Consequently, the occurrence of magnetic saturation can be suppressed on both sides of the second hole 12f in the circumferential direction R1.

According to the first embodiment, the second hole 12f is arranged on the straight line S passing through the first hole 12e and extending in the radial direction. This facilitates securing the shortest path through which the magnetic flux F1 flows, between the first hole 12e and the second hole 12f. In general, the magnetic flux has the property of flowing through the shortest path. Thus, the magnetic flux F1, which passes through both sides of the second hole 12f in the circumferential direction R1, flows toward the first hole 12e through the shortest path. Therefore, variation in the amount of magnetic flux on both sides of the first hole 12e in the circumferential direction R1 is less likely to occur. Consequently, the occurrence of magnetic saturation can be further suppressed.

According to the first embodiment, the first hole 12e and the second hole 12f are arranged on the straight line S in such a manner that the center point P1 of the first hole 12e and the center point P2 of the second hole 12f are located on the straight line S. This further facilitates securing the shortest path through which the magnetic flux F1 flows, between the first hole 12e and the second hole 12f. Thus, the magnetic flux F1 can easily flow actively between the first hole 12e and the second hole 12f, so that the iron loss in the stator core 10 can be further reduced.

According to the first embodiment, the bottom of the first hole 12e and the bottom of the second hole 12f correspond to the end surface 11e of the first core part 11 in the z-axis direction. That is, the first core part 11 has no hole that is used to fix the insulator 20. Thus, the magnetic flux exiting from the permanent magnet 72 can easily flow through the first core part 11. Consequently, an increase in iron loss in the stator core 10 can be prevented, and thus the efficiency of the motor 100 having the stator 1 can be improved.

According to the first embodiment, the opening 12u of the first hole 12e and the opening 12v of the second hole 12f are circular. Thus, the first hole 12e and the second hole 12f can be easily formed in the second core part 12 by the punching process.

According to the first embodiment, the insulator 20 is formed of a PBT resin. In general, a PBT resin has a weaker tensile strength than other resin materials, and thus is easily elastically deformed. Thus, when the work of mounting the insulator 20 onto the second core part 12 is performed, the insulator 20 is appropriately deformed elastically. Therefore, the first convex portion 20a can easily fit into the first hole 12e, and the second convex portion 20b can easily fit into the second hole 12f. Accordingly, the work of mounting the insulator 20 is facilitated.

### Second Embodiment

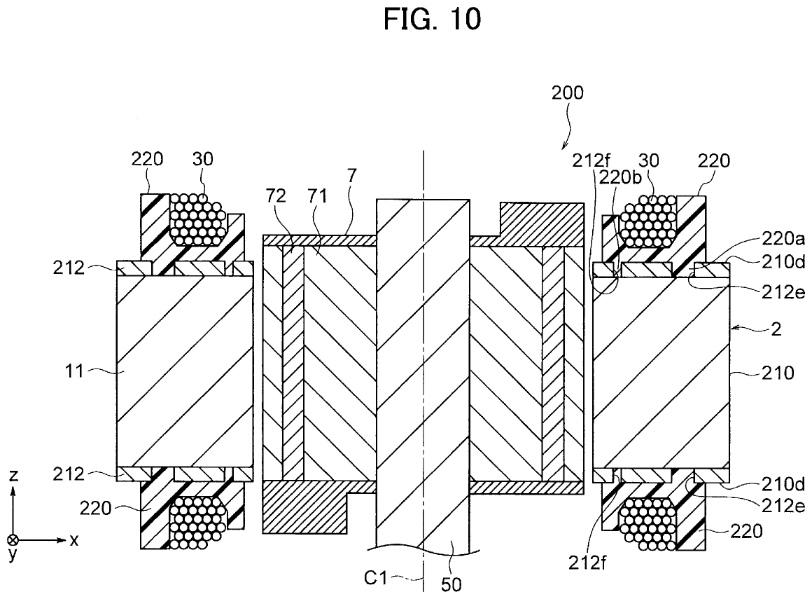

FIG. 10 is a sectional view illustrating the configuration of a motor 200 according to a second embodiment. FIG. 11 is an enlarged plan view illustrating the configuration of a second core part 212 of a stator 2 according to the second embodiment. In FIGS. 10 and 11, components identical or corresponding to those illustrated in FIGS. 2 and 5 are denoted by the same reference characters as those illustrated in FIGS. 2 and 5. The stator 2 according to the second embodiment differs from the stator 1 according to the first embodiment in the shape of a first hole 212e.

As illustrated in FIG. 10, the motor 200 has the stator 2 and the rotor 7. The stator 2 includes a stator core 210, insulators 220 provided on the teeth of the stator core 210, and the coils 30 wound around the teeth via the insulators 220. The stator core 210 has a first core part 11 and second core parts 212 which are arranged in the z-axis direction.

As illustrated in FIGS. 10 and 11, the second yoke portion 12a of the second core part 212 has the first hole 212e provided in an end surface 210d in the z-axis direction. The second tooth portion 12b of the second core part 212 has a second hole 212f provided in the end surface 210d. In the second embodiment, as viewed in the z-axis direction, the area of the second hole 212f is smaller than the area of the first hole 212e. In other words, the diameter Φ₂ of the second hole 212f is smaller than the diameter Φ₁ of the first hole 212e. For example, the diameter Φ₂ of the second hole 212f is 4 mm, while the diameter Φ₁ of the first hole 212e is 6 mm.

Here, as illustrated in FIG. 11, D₂ represents a distance between the edge of the second hole 212f and a plane V including the side surface 12g of the second tooth portion 12b, and D₁ represents a distance between the edge of the first hole 212e and the plane V. The distance D₂ is longer than the distance D₁. That is, the distance D₁ and the distance D₂ satisfy the following formula (1).

D₂>D₁ (1)

This is because the area of the second hole 212f is smaller than the area of the first hole 212e as viewed in the z-axis direction.

FIG. 12 is a schematic diagram illustrating the flow of magnetic flux F2 in the second core part 212 illustrated in FIG. 11. As described above, in the second embodiment, since the distance D₂ is longer than the distance D₁, the magnetic flux F2 flows more easily through between the edge of the second hole 212f and the side surface 12g of the second tooth portion 12b. Thus, the occurrence of magnetic saturation between the edge of the second hole 212f and the side surface 12g can be further suppressed. Consequently, iron loss in the stator 2 is further reduced, and a reduction in the efficiency of the motor 200 can be suppressed.

The effect exhibited by making the area of the second hole 212f smaller than the area of the first hole 212e as viewed in the z-axis direction will be described here by comparison with the first embodiment and a comparative example. A motor according to the comparative example differs from the motor 100 according to the first embodiment in that the motor according to the comparative example has no second hole 12f. In the motor 100 according to the first embodiment, Do is defined as the distance between the edge of the second hole 12f and the side surface 12g of the second tooth portion 12b (see FIG. 5). For example, while the efficiency of the motor according to the comparative example is 95%, the efficiency of the motor 100 according to the first embodiment is 94%, and the efficiency of the motor 200 according to the second embodiment is 94.8%. That is, the motor 200 according to the second embodiment can suppress the reduction in the motor efficiency, as compared to the motor 100 according to the first embodiment. This is because the distance D₂ is longer than the distance D₀.

(Effects of Second Embodiment)

According to the second embodiment described above, as viewed in the z-axis direction, the area of the second hole 212f is smaller than the area of the first hole 212e. Thus, the magnetic flux F2 flows more easily through between the edge of the second hole 212f and the side surface 12g of the second tooth portion 12b. Therefore, the occurrence of magnetic saturation between the edge of the second hole 212f and the side surface 12g of the second tooth portion 12b can be further suppressed.

### Third Embodiment

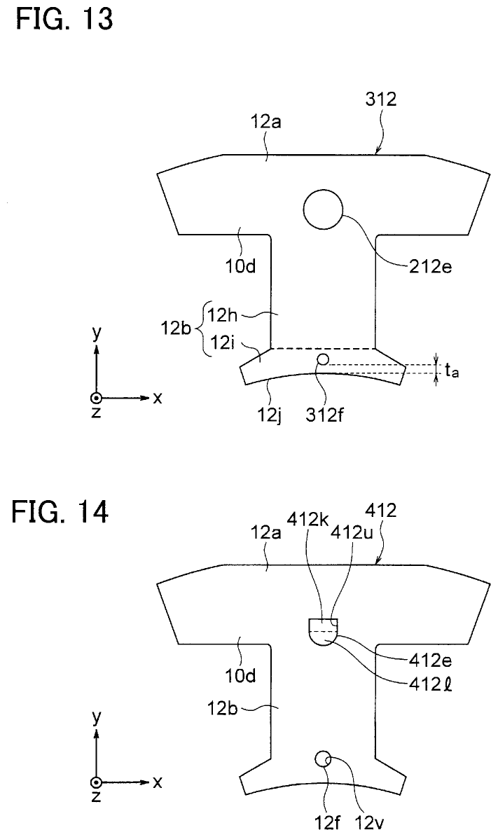

FIG. 13 is an enlarged plan view illustrating the configuration of a second core part 312 of a stator core of a stator according to a third embodiment. In FIG. 13, components identical or corresponding to those illustrated in FIG. 11 are denoted by the same reference characters as those denoted in FIG. 11. The stator according to the third embodiment differs from the stator 2 according to the second embodiment in the position of a second hole 312f. The stator according to the third embodiment is the same as the stator 2 according to the second embodiment in other respects. The following description is made with reference to FIG. 11.

As illustrated in FIG. 13, the stator core of the stator according to the third embodiment has the first core part 11 and second core parts 312 which are arranged in the z-axis direction. The second tooth portion 12b of each second core part 312 has a tooth main body 12h and a tooth tip end 12i. The tooth main body 12h extends inward in the radial direction from the second yoke portion 12a. The tooth tip end 12i is disposed on the inner side of the tooth main body 12h in the radial direction and is wider in the circumferential direction R1 than the tooth main body 12h. In the third embodiment, a second hole 312f is provided in the tooth tip end 12i. Thus, the distance between the center point P1 of the first hole 212e and the center point P2 of the second hole 312f increases, and magnetic flux density between the first hole 212e and the second hole 312f decreases. Therefore, the occurrence of magnetic saturation between the first hole 212e and the second hole 312f can be suppressed.

When ta represents the thickness between the edge of the second hole 312f and a surface 12j of the tooth tip end 12i on the inner side in the radial direction (hereinafter also referred to as an “inner circumferential surface”), the thickness tₐ is greater than or equal to a sheet thickness tₘ of each electromagnetic steel sheet 15 (see FIG. 7). That is, the thickness tₐ and the sheet thickness tₘ of one electromagnetic steel sheet 15 satisfy the following formula (2).

tₐ≥tₘ (2)

Thus, it is possible to suppress an increase in iron loss in the second core part 12 due to a processing strain generated when the electromagnetic steel sheet 15 is punched to form the second hole 312f.

### (Effects of Third Embodiment)

According to the third embodiment described above, the second hole 312f is provided in the tooth tip end 12i of the second tooth portion 12b. Thus, the distance between the center point P1 of the first hole 212e and the center point P2 of the second hole 312f increases, and magnetic flux density between the first hole 212e and the second hole 312f decreases. Therefore, the occurrence of magnetic saturation between the first hole 212e and the second hole 312f can be suppressed.

According to the third embodiment, the thickness to between the edge of the second hole 312f and the inner circumferential surface 12j of the tooth tip end 12i is greater than or equal to the sheet thickness tₘ of each electromagnetic steel sheet 15. Thus, it is possible to suppress an increase in iron loss in the second core part 12 due to a processing strain generated when the electromagnetic steel sheet 15 is punched to form the second hole 312f.

### Fourth Embodiment

FIG. 14 is an enlarged plan view illustrating the configuration of a second core part 412 of a stator core of a stator according to a fourth embodiment. In FIG. 14, components identical or corresponding to those illustrated in FIG. 5 are denoted by the same reference characters as those illustrated in FIG. 5. The stator according to the fourth embodiment differs from the stator 1 according to the first embodiment in the shape of a first hole 412e. The stator according to the fourth embodiment is the same as the stator 1 according to the first embodiment in other respects. The following description is made with reference to FIG. 2.

As illustrated in FIG. 14, a stator core 10 of the stator according to the fourth embodiment has the first core part 11 and second core parts 412 which are arranged in the z-axis direction. A second yoke portion 12a of each second core part 412 has the first hole 412e provided in the end surface 10d in the z-axis direction. The second tooth portion 12b of the second core part 412 has the second hole 12f provided in the end surface 10d in the z-axis direction. In the fourth embodiment, the shape of an opening 412u of the first hole 412e is different from the shape of the opening 12v of the second hole 12f. Specifically, the opening 12v of the second hole 12f is circular, while the opening 412u of the first hole 412e is non-circular.

The opening 412u of the first hole 412e has a semicircular portion 412l and a rectangular portion 412k leading to the semicircular portion 412l. That is, in the fourth embodiment, the opening 412u of the first hole 412e has corner portions. The rectangular portion 412k functions as a detent portion. Thus, when the work of winding the coil 30 around the tooth 10b via the insulator 20 is performed, the insulator 20 is less likely to rotate about the first hole 412e. Incidentally, the shape of the rectangular portion 412k as viewed in the z-axis direction is not limited to an oblong, but may be any other rectangle such as a square. The opening of the second hole 412f may have a rectangular portion.

### (Effects of Fourth Embodiment)

According to the fourth embodiment described above, the opening 412u of the first hole 412e has the rectangular portion 412k. Thus, when the work of winding the coil 30 around the tooth 10b via the insulator 20 is performed, the insulator 20 is less likely to rotate about the first hole 412e. Thus, the occurrence of misalignment of the insulator 20 can be prevented.

### Fifth Embodiment

FIG. 15 is a sectional view illustrating the configuration of a motor 500 according to a fifth embodiment. In FIG. 15, components identical or corresponding to those illustrated in FIG. 2 are denoted by the same reference characters as those illustrated in FIG. 2. A stator 5 of the motor 500 according to this embodiment differs from the stator 1 according to the first embodiment in that the depth of a first hole 512e is different from the depth of a second hole 512f.

As illustrated in FIG. 15, the motor 500 has the stator 5 and the rotor 7. The stator 5 includes a stator core 510 having a yoke and teeth, insulators 520 provided on the teeth of the stator core 510, and coils 30 wound around the teeth of the stator core 510 via the insulators 520. The stator core 510 has a first core part 511 and second core parts 512 which are arranged in the z-axis direction.

The yoke of the stator core 510 has the first hole 512e provided in an end surface 510d in the z-axis direction. The tooth of the stator core 510 also has the second hole 512f provided in the end surface 510d. In the fifth embodiment, a depth L2 of the second hole 512f is shallower than a depth L₁ of the first hole 512e. For example, the depth L₂ of the second hole 512f is 0.5 mm, and the depth L₁ of the first hole 512e is 0.75 mm.

In the fifth embodiment, since the depth L₂ of the second hole 512f is shallower than the depth L₁ of the first hole 512e, the second hole 512f does not penetrate the second core part 512 in the z-axis direction. Thus, in the stator core 510, a portion where magnetic flux flows is formed between the bottom of the second hole 512f and an end surface 511e in the z-axis direction of the first core part 511. Consequently, the magnetic flux exiting from the permanent magnet 72 easily flows through the second core part 512, and thus the occurrence of magnetic saturation in the second core part 512 can be further prevented.

The insulator 520 has a first convex portion 520a that fits into the first hole 512e and a second convex portion 520b that fits into the second hole 512f. Thus, the insulator 520 can be firmly fixed to the stator core 510 when the work of winding the coil 30 around the tooth of the stator core 510 via the insulator 520 is performed. Consequently, the occurrence of misalignment of the insulator 520 can be prevented when the work of winding the coil 30 is performed.

### (Effects of Fifth Embodiment)

According to the fifth embodiment described above, the depth L2 of the second hole 512f is shallower than the depth L₁ of the first hole 512e. Thus, in the stator core 510, a portion where magnetic flux flows is formed between the bottom of the second hole 512f and the end surface 511e in the z-axis direction of the first core part 511. Consequently, the magnetic flux exiting from the permanent magnet 72 easily flows through the second core part 512, and thus the occurrence of magnetic saturation in the second core part 512 can be further suppressed.

### Sixth Embodiment

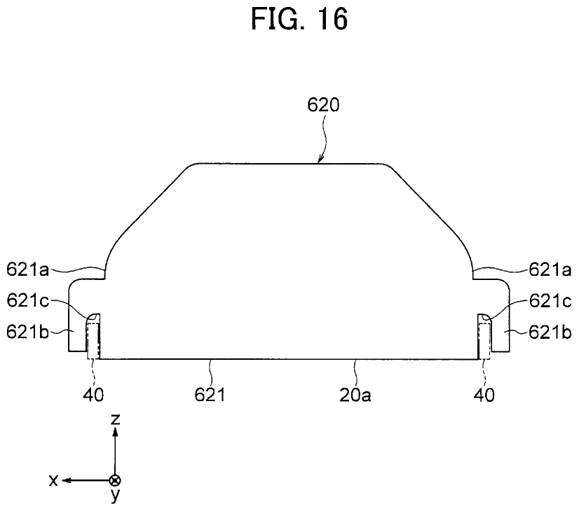

FIG. 16 is a diagram illustrating the configuration of an insulator 620 of a stator according to a sixth embodiment. The stator according to the sixth embodiment differs from the stator 1 according to the first embodiment in that the insulator 620 has mounting portions 621b for fixing insulating films 40. The stator according to the sixth embodiment is the same as the stator 1 according to the first embodiment in other respects. The following description is made with reference to FIGS. 1 and 9.

The insulator 620 has a first insulating portion 621 that covers the yoke 10a of the stator core 10, and the second insulating portion 22 that covers the tooth 10b of the stator core 10. FIG. 16 is a diagram illustrating the first insulating portion 621 of the insulator 620 as viewed from the outer side in the radial direction.

The first insulating portion 621 has the mounting portions 621b each of which protrudes from a side surface 621a of the first insulating portion 621 that faces in the circumferential direction R1. Each mounting portion 621b is used to fix the insulating film 40. The mounting portion 621b has a groove 621c that is recessed toward the outer side in the axial direction. By inserting the insulating film 40 into the groove 621c, the insulating film 40 is fixed to the insulator 20. Thus, the insulating film 40 is less likely to be released when the work of winding the coil 30 around the tooth 10b is performed. Consequently, it is possible to maintain the state where the insulating film 40 insulates the side surface of the tooth 10b and the coil 30 from each other. Incidentally, the mounting portion 621b may be provided in the second insulating portion 22 of the insulator 620.

### (Effects of Sixth Embodiment)

According to the sixth embodiment described above, the insulator 620 has the mounting portion 621b for fixing the insulating film 40. Thus, the insulating film 40 is less likely to be released during the work of winding the coil 30 around the tooth 10b. Consequently, it is possible to maintain the state where the insulating film 40 is disposed between the coil 30 and the side surface of the tooth 10b facing in the circumferential direction R1.

### Seventh Embodiment

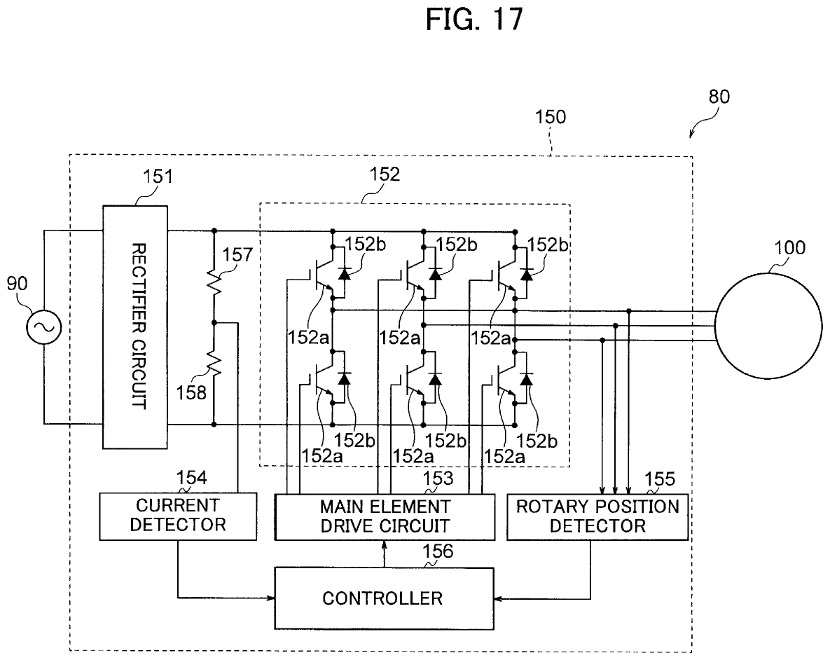

Next, a motor drive device 80 according to a seventh embodiment for driving the motor of any of the first to sixth embodiments described above will be described. FIG. 17 is a diagram illustrating the configuration of the motor drive device 80. Hereinafter, the motor drive device 80 to drive the motor 100 according to the first embodiment will be described by way of example.

The motor drive device 80 has a drive circuit 150 that drives the motor 100. The drive circuit 150 has a rectifier circuit 151 and an inverter 152. The rectifier circuit 151 converts AC voltage supplied from a commercial AC power source 90 to DC voltage.

The inverter 152 is connected to the motor 100 via terminals 806 of the compressor 800 illustrated in FIG. 18 to be described later. The inverter 152 converts the DC voltage, which is converted by the rectifier circuit 151, into a high-frequency voltage and then applies the high-frequency voltage to the coils 30 (see FIG. 1) of the motor 100. The inverter 152 has a plurality of (six in FIG. 17) inverter switches 152a as inverter main elements, and a plurality of (six in FIG. 16) flywheel diodes 152b. Each inverter switch 152a is, for example, an Insulated Gate Bipolar Transistor (IGBT).

The drive circuit 150 further has a main element drive circuit 153, a current detector 154, a rotary position detector 155, and a controller 156. The main element drive circuit 153 drives the inverter switches 152a of the inverter 152. The current detector 154 detects a voltage value between both ends of each of voltage-dividing resistances 157 and 158 arranged between the rectifier circuit 151 and the inverter 152, and then outputs the detected voltage value to the controller 156. The rotary position detector 155 detects the rotary position of the rotor 7 (see FIG. 1) of the motor 100 as detection information and then outputs the detection information to the controller 156.

The controller 156 calculates an output voltage of the inverter 152 to be supplied to the motor 100, based on a command signal regarding the target rotating speed or the positional information of the rotor 7 which is output from the rotary position detector 155. The controller 156 outputs the calculated output voltage to the main element drive circuit 153 as a PWM signal. The motor 100 can perform a wide range of operation from a low speed to a high speed by varying its rotating speed and torque through the variable speed drive under a Pulse Width Modulation (PWM) control by the inverter switches 152a. Since the motor 100 is driven by the inverter 152, it is possible to suppress the effect of load fluctuation.

### Eighth Embodiment

Next, the compressor 800 according to an eighth embodiment to which the motor according to each embodiment described above is applicable will be described. FIG. 18 is a partially sectional view illustrating the configuration of the compressor 800. As illustrated in FIG. 18, the compressor 800 is, for example, a rotary compressor. Incidentally, the compressor 800 is not limited to the rotary compressor, but may be other compressors such as a low-pressure compressor or a scroll compressor. Hereinafter, the compressor 800 having the motor 100 according to the first embodiment will be described by way of example.

The compressor 800 includes the shaft 50 as a rotating shaft, the motor 100, a compression mechanism 801, a sealed container 802, and an accumulator 803. The motor 100 drives the compression mechanism 801. In FIG. 17, the motor 100 is disposed on the downstream side of the compression mechanism 801 in the direction of the flow of refrigerant. The compression mechanism 801 compresses the refrigerant supplied from the accumulator 803. The shaft 50 connects the compression mechanism 801 and the motor 100 to each other. The shaft 50 has a shaft main body 51 fixed to the rotor 7 of the motor 100 and an eccentric shaft portion 52 fixed to the compression mechanism 801.

The compression mechanism 801 has a cylinder 811, a rolling piston 812, an upper frame 813, and a lower frame 814.

The cylinder 811 has a suction port 811a and a cylinder chamber 811b. The suction port 811a is connected to the accumulator 803 via a suction pipe 804. The suction port 811a is a passage through which the refrigerant sucked therein from the accumulator 803 flows and communicates with the cylinder chamber 811b. The cylinder chamber 811b is a space which is cylindrical about the axis C1. The eccentric shaft portion 52 of the shaft 50 and the rolling piston 812 are disposed within the cylinder chamber 811b.

The rolling piston 812 is fixed to the eccentric shaft portion 52 of the shaft 50. The upper frame 813 and the lower frame 814 close the ends in the z-axis direction of the cylinder chamber 811b. Both of the upper frame 813 and the lower frame 814 have respective bearings that rotatably support the shaft 50. An upper discharge muffler 815 and a lower discharge muffler 816 are attached to the upper frame 813 and the lower frame 814, respectively.

The sealed container 802 houses the motor 100, the compression mechanism 801, and the shaft 50. The sealed container 802 is formed of, for example, a steel sheet. The stator 1 of the motor 100 is fixed to an inner wall of the sealed container 802 by shrink-fitting, press-fitting, welding, or the like. At the bottom of the sealed container 802, refrigerant oil (not shown) is retained to lubricate the compression mechanism 801.

The accumulator 803 is attached to the sealed container 802. The refrigerant which is a mixture of a low-pressure liquid refrigerant and gas refrigerant is supplied into the accumulator 803 from a refrigerant circuit of a refrigeration cycle apparatus to be described later. The accumulator 803 separates the refrigerant into the liquid refrigerant and the refrigerant gas and supplies only the refrigerant gas to the compression mechanism 801.

The compressor 800 further has a discharge pipe 805 and the terminals 806 attached to an upper portion of the sealed container 802. The discharge pipe 805 discharges the refrigerant compressed by the compression mechanism 801 to the outside of the sealed container 802. The terminals 806 are connected to a drive device provided outside the compressor 800 (for example, the motor drive device 80 illustrated in FIG. 17). The terminals 806 supply drive current to the coils 30 of the stator 1 in the motor 100 via lead wires 807.

Next, the operation of the compressor 800 will be described. When the drive current is supplied to the coils 30 from the terminals 806, an attractive force or a repulsive force is generated between the stator 1 and the rotor 7 by a rotating magnetic field and a magnetic field of the permanent magnets 72 of the rotor 7. Thus, the rotor 7 rotates, and the shaft 50 fixed to the rotor 7 also rotates.

A low-pressure refrigerant gas is sucked into the cylinder chamber 811b of the compression mechanism 801 through the suction port 811a. In the cylinder chamber 811b, the eccentric shaft portion 52 of the shaft 50 and the rolling piston 812 rotate eccentrically to compress the refrigerant.

The refrigerant compressed in the cylinder chamber 811b is discharged into the sealed container 802 through the upper discharge muffler 815 and the lower discharge muffler 816. The refrigerant discharged into the sealed container 802 rises inside the sealed container 802 through the through holes 71e of the rotor 7 (see FIG. 9) and the like and is discharged through the discharge pipe 805.

The motor 100 according to the first embodiment described above suppresses the occurrence of magnetic saturation in the stator core 10, so that iron loss is reduced and thus the efficiency of the motor 100 is improved. Since the compressor 800 has the motor 100, the operation efficiency of the compressor 800 can also be improved.

### Ninth Embodiment

Next, a refrigeration cycle apparatus according to a ninth embodiment to which the compressor 800 illustrated in FIG. 18 is applicable will be described. In the following description, an air conditioner 900 to which the refrigeration cycle apparatus is applied will be explained by way of example. Incidentally, the refrigeration cycle apparatus is not limited to the air conditioner 900, but may be applied to other devices such as refrigerators or heat pump cycle apparatuses.

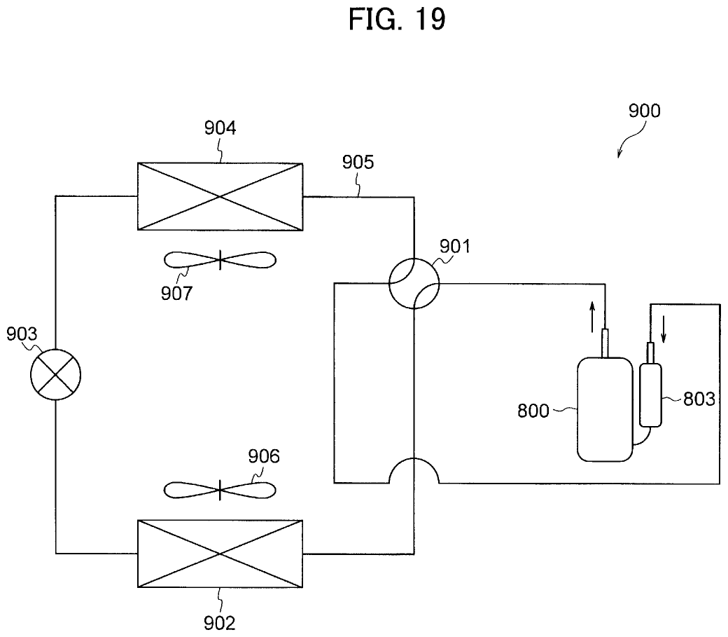

FIG. 19 is a diagram illustrating the configuration of the air conditioner 900. The air conditioner 900 includes the compressor 800, a four-way valve 901, an outdoor heat exchanger 902, an expansion valve 903 as a decompression device, and an indoor heat exchanger 904. The compressor 800, the four-way valve 901, the outdoor heat exchanger 902, the expansion valve 903, and the indoor heat exchanger 904 are connected by a refrigerant pipe 905. In this way, the refrigerant circuit is configured in the air conditioner 900. The air conditioner 900 further includes an outdoor fan 906 facing the outdoor heat exchanger 902 and an indoor fan 907 facing the indoor heat exchanger 904.

Next, the operation of the air conditioner 900 will be described. Hereinafter, the operation of the air conditioner 900 during a cooling operation will be described. The compressor 800 compresses the refrigerant sucked therein from the accumulator 803 and discharges the compressed refrigerant as a high-temperature and high-pressure refrigerant gas. The four-way valve 901 is a switching valve that switches the flow direction of the refrigerant. During the cooling operation, the four-way valve 901 allows the refrigerant discharged from the compressor 800 to flow to the outdoor heat exchanger 902. The outdoor heat exchanger 902 exchanges heat between the high-temperature and high-pressure refrigerant gas and a medium (for example, air) to condense the refrigerant gas, and discharges the condensed refrigerant as a low-temperature and high-pressure liquid refrigerant. That is, during the cooling operation, the outdoor heat exchanger 902 functions as the condenser.

The expansion valve 903 expands the liquid refrigerant discharged from the outdoor heat exchanger 902 and then discharges the expanded refrigerant as a low-temperature and low-pressure liquid refrigerant. The indoor heat exchanger 904 exchanges heat between the low-temperature and low-pressure liquid refrigerant discharged from the outdoor heat exchanger 902 and a medium (for example, air) to evaporate the liquid refrigerant, and then discharges the evaporated refrigerant gas. That is, during the cooling operation, the indoor heat exchanger 904 functions as the evaporator. Thus, air from which the heat is removed in the indoor heat exchanger 904 is supplied by the indoor fan 907 to the interior of a room which is a space to be air-conditioned.

The refrigerant gas discharged from the indoor heat exchanger 904 returns to the compressor 800. Thus, during the cooling operation, the refrigerant circulates through the compressor 800, the outdoor heat exchanger 902, the expansion valve 903, and the indoor heat exchanger 904 in this order. Incidentally, during a heating operation, the four-way valve 901 allows the high-temperature and high-pressure refrigerant gas discharged from the compressor 800 to flow to the indoor heat exchanger 904. Thus, during the heating operation, the indoor heat exchanger 904 functions as the condenser, while the outdoor heat exchanger 902 functions as the evaporator.

The compressor 800 according to the eighth embodiment has improved operation efficiency as described above. The air conditioner 900 has the compressor 800, and thus the operation efficiency of the air conditioner 900 can also be improved.

1. A stator comprising:
a stator core having a yoke and a tooth;
an insulator provided on the tooth; and
a coil wound around the tooth via the insulator,
wherein the yoke has a first hole provided in an end surface in an axial direction of the stator core,
wherein the tooth has a tooth main body extending inward in the radial direction from the yoke, and a tooth tip end arranged on an inner side in the radial direction with respect to the tooth main body, the tooth tip end being wider in the circumferential direction of the stator core than the tooth main body, the tooth having a second hole provided in the end surface,
wherein the second hole is provided at a center of the tooth in a circumferential direction of the stator core and arranged on a straight line passing through the first hole and extending in a radial direction of the stator core,
wherein the insulator has a first convex portion fitting into the first hole and a second convex portion fitting into the second hole, and
wherein the second hole is provided in the tooth tip end.

2. The stator according to claim 1, wherein the first hole and the second hole are arranged on the straight line so that a center point of the first hole and a center point of the second hole are located on the straight line.

3. The stator according to claim 1, wherein a center point of the second hole is provided at the center of the tooth in the circumferential direction of the stator core.

4. The stator according to claim 1, wherein, as viewed in the axial direction, an area of the second hole is smaller than an area of the first hole.

5. (canceled)

6. The stator according to claim 1, wherein the tooth has a tooth main body extending inward in the radial direction from the yoke, and a tooth tip end arranged on an inner side in the radial direction with respect to the tooth main body, the tooth tip end being wider in the circumferential direction of the stator core than the tooth main body, and
wherein the second hole is provided in the tooth tip end.

7. The stator according to claim 6, wherein the stator core has a plurality of steel sheets stacked in the axial direction, and
wherein, when tₐ represents a thickness between an inner surface of the tooth tip end in the radial direction and the second hole, and tₘ represents a sheet thickness of one steel sheet among the plurality of steel sheets,
tₐ and tₘ satisfy tₐ≥tₘ.

8. The stator according to claim 1, wherein an opening of at least one of the first hole and the second hole has a circular shape.

9. The stator according to claim 1, wherein an opening of at least one of the first hole and the second hole has a rectangular portion.

10. A stator comprising:
a stator core having a yoke and a tooth;
an insulator provided on the tooth; and
a coil wound around the tooth via the insulator,
wherein the yoke has a first hole provided in an end surface in an axial direction of the stator core,
wherein the tooth has a second hole provided in the end surface,
wherein the second hole is provided at a center of the tooth in a circumferential direction of the stator core and arranged on a straight line passing through the first hole and extending in a radial direction of the stator core, and
wherein the insulator has a first convex portion fitting into the first hole and a second convex portion fitting into the second hole, and
wherein a depth of the second hole is shallower than a depth of the first hole.

11. The stator according to claim 1, wherein the stator core has a first core part and a second core part disposed on an outer side of the first core part in the axial direction, and
wherein the second core part has the first hole and the second hole.

12. The stator according to claim 1, further comprising an insulating film disposed in a slot in the stator core, the slot housing the coil in the stator core,
wherein the insulator further has a mounting portion on which the insulating film is mounted.

13. The stator according to claim 1, wherein the insulator contains a polybutylene terephthalate resin.

14. A motor comprising:
the stator according to claim 1; and
a rotor.

15. The motor according to claim 14, wherein the rotor has a rotor core and a permanent magnet mounted on the rotor core.

16. A compressor comprising:
the motor according to claim 14; and
a compression mechanism to be driven by the motor.

17. A refrigeration cycle apparatus comprising:
the compressor according to claim 16;
a condenser to condense refrigerant discharged from the compressor;
a decompression device to decompress the refrigerant condensed by the condenser; and
an evaporator to evaporate the refrigerant decompressed by the decompression device.

18. An air conditioner comprising the refrigeration cycle apparatus according to claim 17.
